(19) United States
(12) Patent Application Publication
(10) Pub. No.: US 2007/0118284 A1
(43) Pub. Date: May 24, 2007

(54) Customized GPS provisioning

(75) Inventors: Steve Sposato, Lafayette, CA (US); Steven Gemelos, Cupertino, CA (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/285,323

(22) Filed: Nov. 23, 2005

(51) Int. Cl. G01C 21/00

(52) U.S. Cl. 701/213

(57) ABSTRACT

A global positioning satellite device is dynamically provisioned. Global positioning satellite device provisioning information is received for at least one specified location from an information source over a communications network. The received global positioning satellite device provisioning information is transferred to the global positioning satellite device.

### BACKGROUND OF THE INVENTION

1. Field of the Invention

The present disclosure relates to global positioning satellite (GPS) devices. More particularly, the present disclosure relates to provisioning GPS devices with customized address and route data.

2. Background Information

Global positioning satellite (GPS) navigation devices are typically independent units that operate without relying on peripheral communications devices. For example, GPS navigation devices are typically pre-provisioned with receivers that receive signals from GPS satellites, as well as functionality for recognizing their position on earth based on the signals received from GPS satellites.

GPS navigation devices may be provisioned with map images and mapping data at the time of purchase. GPS navigation devices may also be updated by ordering, e.g., a compact disc from a map supplier. As a result, a GPS navigation device may be configured to display detailed map information such as roads and highways. Additionally, a GPS navigation device may contain detailed address data for determining travel routes for a user. A GPS navigation device may also maintain a detailed list of business names associated with address data. As an example, a user may enter a destination street address into a GPS navigation device. The GPS navigation device then generates a route from the user's current location to the destination street address based on the internally pre-provisioned map images and mapping data. As another example, a GPS navigation device may associate business names with addresses. A user may then enter a name of a restaurant chain and obtain a list of restaurants ordered by distance from the device.

The currently available GPS devices are limited in that the data they use is static and pre-configured data that is not updated to account for temporary conditions, such as road construction or traffic. This data can become stale. For example, restaurants, gas stations and other businesses are constantly changing. Additionally, businesses close or move, and new businesses open. Streets and highways also change over time. For example, new streets are added or made temporarily unavailable as they undergo reconstruction.

Additionally, many GPS devices can only store detailed data for a limited region. Once the user leaves the region for which the GPS device has detailed information, the user is left with only basic information such as highways and major streets, but not business locations or addresses.

Other GPS-related services do not resolve the shortcomings described above. For example, a service may provide GPS information from a vehicle GPS navigation device to an operator. However, such services require voice interaction with an operator who then provides information and directions verbally. Additionally, an auto company may offer a 1-way push of the same GPS data to all receivers of a satellite radio company, so that this GPS data may not be particularly relevant to any particular driver.

### BRIEF DESCRIPTION OF THE DRAWINGS

FIG. 1 shows an exemplary general computer system that includes a set of instructions for performing customized GPS provisioning;

FIG. 2 shows an exemplary network configuration for customized GPS provisioning;

FIG. 3 shows another exemplary network configuration for customized GPS provisioning;

FIG. 4 shows another exemplary network configuration for customized GPS provisioning;

FIG. 5 shows an exemplary method for customized GPS provisioning; and

FIG. 6 shows another exemplary method for customized GPS provisioning.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure a method is provided for dynamically provisioning a global positioning satellite device. The method includes receiving global positioning satellite device provisioning information for at least one specified location from an information source over a communications network. The method also includes transferring the received global positioning satellite device provisioning information to the global positioning satellite device.

According to another aspect of the present disclosure, the method for dynamically provisioning a global positioning satellite device includes requesting the global positioning satellite device provisioning information from the information source over a wireless network.

According to still another aspect of the present disclosure, the request for global positioning satellite device provisioning information is made from a wireless access device and the global positioning satellite device provisioning information is received by the wireless access device.

According to yet another aspect of the present disclosure, the method for dynamically provisioning a global positioning satellite device includes transmitting an identifier of the wireless access device with the request for global positioning satellite device provisioning information.

According to another aspect of the present disclosure, the request for global positioning satellite device provisioning information is made to an information service that forwards the requested global positioning satellite device provisioning information when the identifier is associated with a subscriber account.

According to still another aspect of the present disclosure, the global positioning satellite device provisioning information received from the information source over the wireless network includes multiple alternative locations. According to yet another aspect of the present disclosure, the global positioning satellite device provisioning information received from the information source over the wireless network is used by the global positioning satellite device to determine a route from a current location of the global positioning satellite device to a location corresponding to the global positioning satellite device provisioning information.

According to another aspect of the present disclosure, the request is made over the wireless network to a remote information source.

According to still another aspect of the present disclosure, the wireless network is a local area network.

According to an aspect of the present disclosure a computer readable medium is provided for storing a computer program that dynamically provisions a global positioning satellite device. The computer readable medium includes an information receiving code segment that receives global positioning satellite device provisioning information for at least one specified location from an information source. The computer readable medium also includes an information transferring code segment that transfers the received global positioning satellite device provisioning information to the global positioning satellite device.

According to another aspect of the present disclosure, the global positioning satellite device provisioning information is received as an email.

According to still another aspect of the present disclosure, the global positioning satellite device provisioning information is received as a text message.

According to yet another aspect of the present disclosure, the global positioning satellite device provisioning information is transferred over a network that conforms to an Institute of Electrical and Electronics Engineers 802.11 protocol.

According to another aspect of the present disclosure, the global positioning satellite device provisioning information includes map data that is used to display a route from a current location to the at least one specified location.

According to an aspect of the present disclosure, a device is provided for dynamically provisioning a global positioning satellite device. The device includes a receiver that receives global positioning satellite device provisioning information for at least one specified location from an information source. The device also includes a transmitter that transfers the received global positioning satellite device provisioning information to the global positioning satellite device.

According to another aspect of the present disclosure, the device for dynamically provisioning a global positioning satellite device is a cell phone.

According to still another aspect of the present disclosure, the device for dynamically provisioning a global positioning satellite device is a personal data assistant.

According to yet another aspect of the present disclosure, the device for dynamically provisioning a global positioning satellite device is a laptop computer.

According to another aspect of the present disclosure, the global positioning satellite device provisioning information is received over a cellular network.

According to still another aspect of the present disclosure, the global positioning satellite device provisioning information is received over a wireless data network.

According to yet another aspect of the present disclosure the global positioning satellite device provisioning information is automatically updated based upon a changed location of the global positioning satellite device.

According to another aspect of the present disclosure, the global positioning satellite device provisioning information includes a first map for a first area received at a first time when the global positioning satellite device is at a first location in the first area and a second map for a second area received at a second time when the global positioning satellite device is at a second location in the second area.

As described above, a need exists for customized GPS provisioning. The present disclosure describes such customized GPS provisioning at the whim of a user. For example, the present disclosure describes interactive GPS mapping over one or more 2-way wireless data links. Further, the present disclosure describes provisioning a GPS device by pushing customized data through a wireless network to an addressable wireless access device that provisions a GPS device.

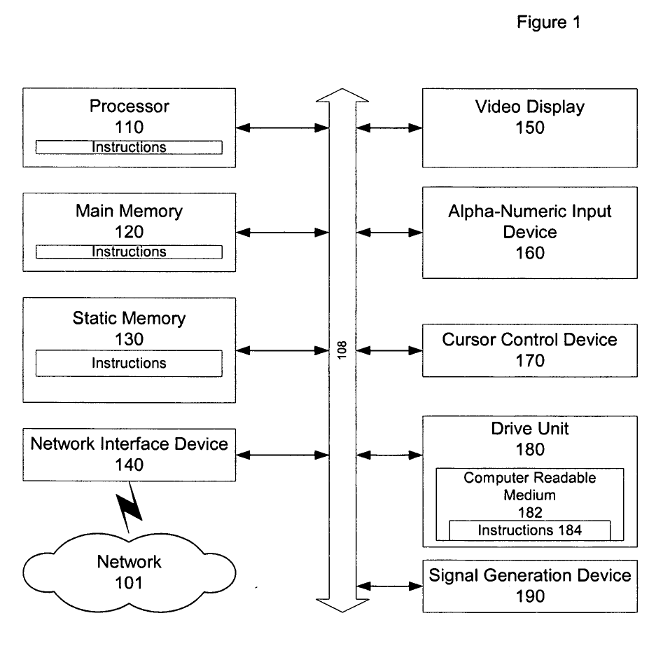

Referring to FIG. 1, an illustrative embodiment of a general computer system, on which customized GPS provisioning can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, an internet protocol (IP telephone), a palmtop computer, a laptop computer, a desktop computer, a communications device, a wireless telephone, a control system, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

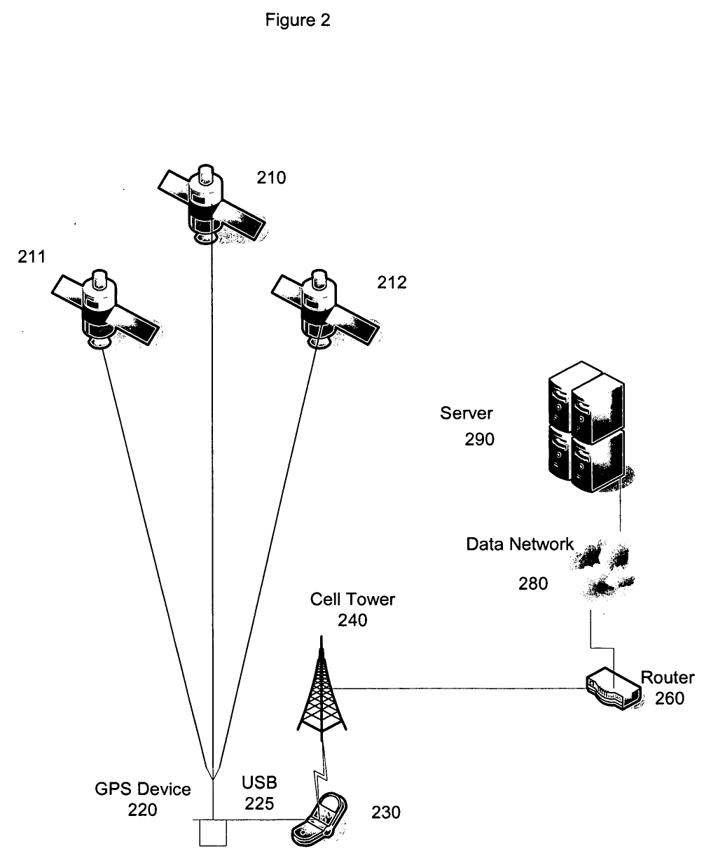

FIG. 2 shows an exemplary network configuration for customized GPS provisioning. As shown, a mobile GPS device 220 receives synchronizing signals from representative GPS satellites 210-212 and determines a current location using the synchronizing signals. The GPS device 220 in FIG. 2 may be, for example, a GPS navigation device that displays current location to a user using a display screen.

In the embodiment shown in FIG. 2, the GPS device 220 is connected through a USB wire 225 to a cell phone 230. Of course, the connection between a GPS device 220 and a wireless access device (such as a cell phone) is not limited to USB wire 225. For example, in another embodiment, a GPS device 220 is connected to a wireless access device using wireless fidelity (WiFi) functionality provided to the GPS device 220 and the wireless access device. In still another embodiment, a GPS device 220 is connected to a wireless access device using a Bluetooth connection.

The cell phone 230 communicates over a cellular network exemplified by a cell tower 240 shown in FIG. 2. In the embodiment shown in FIG. 2, data from the cell tower 240 is forwarded to a router 260. The data from the cell tower 240 may be converted into an appropriate format and/or protocol before transmission to the router. The router 260 routes the data through a data network 280 to a server 290.

In the embodiment shown in FIG. 2, the GPS device 220 uses the cell phone 230 to communicate over the cellular network and the data network 280. In this regard, a user enters instructions into the GPS device 220, and the GPS device 220 uses the cell phone 230 to transmit and receive information. For example, an application on the GPS device 220 may be configured to request maps on-demand from a remote information source for a specified location (e.g., the current location of the GPS device 220). The cell phone 230 can be used to request and retrieve the map using text messaging, email, instant messaging, wireless data transfer or any other appropriate communications protocol or format. For example, the server 290 can push data back to the cell phone 230 using text messaging (as an email to the cell phone 230), wireless data transfer, or by loading the data into the cell phone memory. In the embodiment shown in FIG. 2, the data network 280 may be an IP network 280.

In response to the request, the user of the cell phone 230 receives global positioning satellite device provisioning information for the specified location(s) from the server 290. The global positioning satellite device provisioning information received by the cell phone 230 is transferred to the global positioning satellite device 220 either automatically or when the user enters a command into either the cell phone or the global positioning satellite device 220.

Accordingly, in the embodiment shown in FIG. 2, the user may obtain GPS provisioning information using a real-time 2-way cell phone data link. The GPS device 220 has a USB connection which is used to download GPS information from the cell phone 230. The downloaded GPS information may be GPS coordinates, detailed maps, addresses, business locations, or any other detailed information that can be used to update the GPS device 220.

In another example, the server 290 may provide a subscription service to provision GPS devices with customized information. The user of the GPS device 220 may be authenticated as a subscriber of a subscription service based upon, for example, an identifier of the wireless access device, such as a telephone number of the cell phone 230. Alternatively, the user of the GPS device 220 may be authenticated as a subscriber of a subscription service based upon, for example, information which identifies the GPS device, such as a serial number. The data services which can be provided using customized GPS provisioning include real-time traffic reports and road conditions that can be used by the GPS to route around problem areas. The user can program the GPS device 220 to display a route from a current location to a destination, and the server 290 can provide information regarding roads and highways to avoid. Accordingly, the GPS device 220 can calculate a new route avoiding the problem areas.

Detailed business location information may also be provided as a data service using customized GPS provisioning. A data service can be used to verify addresses for regions stored in memory, or even to pull information for regions not stored in memory. Additionally, even a GPS device 220 without mapping or routing capabilities can have a route downloaded to it through the cell phone 230 as a linked series of GPS coordinates.

Emergency services may also be provided using customized GPS provisioning. For example, a cell phone can be used to retrieve an updated GPS map so that a user can obtain relevant GPS mapping information for their current location. This information could then be used to summons an auto service or public safety official. Public safety officials may be able to transmit mapping data to a caller's cell phone, such that the caller can use the GPS device 220 to provide detailed location information.

In the embodiment of FIG. 2, the user is remote from a computer and not able to search for data directly. Accordingly, the cell phone 230 is used to communicate a request from the GPS device 220, and to receive a response to the request. The data of the response is obtained using the server 290 and pushed to the GPS device 220 through the cell phone 230.

In another embodiment, the GPS device 220 may be configured to initiate requests for information as it travels through areas for which it does not have global positioning satellite device provisioning information such as a map. For example, the GPS device 220 may track its own location and recognize when its location is outside of any area for which it has received map information. Accordingly, the GPS device 220 may initiate an automated request to a service to obtain information for the unfamiliar area, and download the service through the cell phone 230 without requiring input or interaction of the user of the GPS device 220 and the cell phone 230. Of course, the GPS device 220 may initiate such a request even when it has relevant provisioning information for an area, but the relevant provisioning information has not been recently updated.

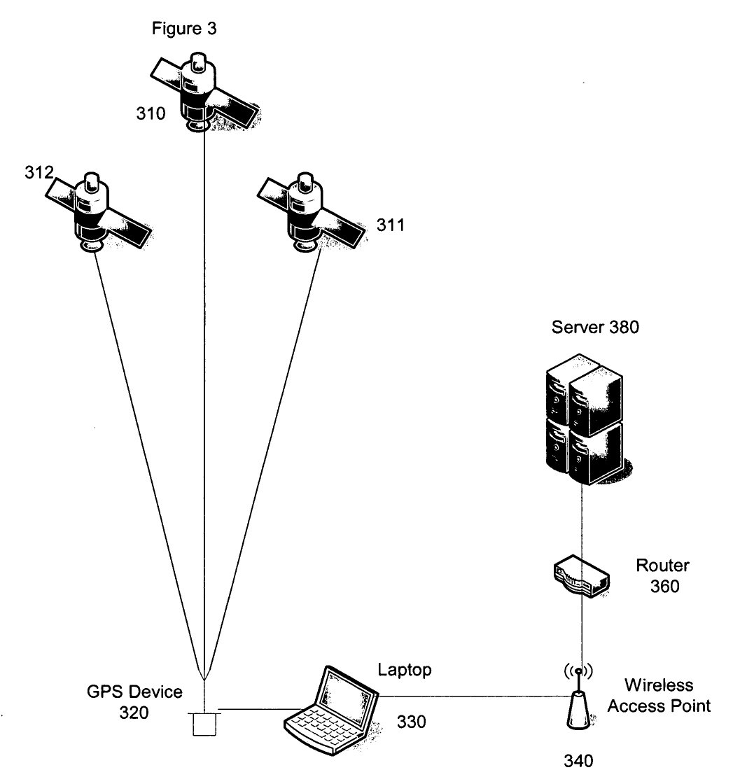

FIG. 3 shows another exemplary network configuration for customized GPS provisioning. In the embodiment of FIG. 3, a laptop 330 connects to a wireless access point 340 using, e.g., WiFi functionality, such as functionality which complies with an Institute of Electrical and Electronics Engineers (IEEE) 802.11 protocol. Of course, the a wireless access device may connect to a wireless access point 340 using any other wireless standard or technology, such as Bluetooth, GMS, CDMA, GPRS or WiMax.

A request from the laptop 330 is routed via a router 360 to a server 380. The server 380 provides a service that enables a user to request and retrieve GPS provisioning information such as traffic updates, updated business information, map routes for regions which are not provisioned on the GPS device 320, or any other information that can be used to provision and update the GPS device 320, which communicates with representative GPS satellites 310-312.

In the embodiment of FIG. 2, an application for requesting information on-demand for the GPS device 220 resides on the GPS device 220. However, in the embodiment of FIG. 3, an application for requesting information on-demand for the GPS device 320 may reside on either the GPS device 320 or the laptop 330. Accordingly, a user may use the functionality of the laptop 330 to obtain GPS information on-demand, to store retrieved GPS information, and to provision the GPS device 320 with the stored information.

According to the embodiment shown in FIG. 3, interaction occurs between the laptop 330 and a server 380. The user of the GPS device 320 need only input an information request to the laptop 330, such as a restaurant name or a location destination. The laptop 330 interacts with the server 380 to obtain all relevant information needed to satisfy the user's request. The laptop 330 then updates the GPS device 320 with retrieved GPS provisioning information via, e.g., a USB wire or WiFi functionality.

In the embodiment of FIG. 3, the user may have a program on the laptop computer 330 that interacts with a server 380 over a wireless network. The server 380 may determine a destination location, for example, and then convert a route from a current location or a programmed “start” location to the destination location into individual waypoints to be followed. The server 380 would then forward the route data to the laptop computer 330, which then pushes the data to the GPS device 320. As an example, a user may have an option to right-click information on a mapped route obtained using the laptop 330 from Yahoo Maps provided by the server 380. The user may then push the route, as GPS coordinates, to the GPS device using a “Send To: GPS Device” command.

In another embodiment, WiFi or wireless functionality is provided so that an addressable GPS device 320 with a WiFi connection directly connects to a wireless access point 340 to receive data being pushed from a data source (i.e., without the cell phone 230 in FIG. 2 or the laptop 330 in FIG. 3). Accordingly, the GPS device 320 operates as a stand-alone device that can communicate over the Internet to retrieve provisioning information on-demand.

WiFi connectivity may be added to the GPS device 320 as an adaptor through a USB port, or provided by an external device that is then connected to the GPS device through its USB port. Examples of external devices that can be used to provide a WiFi connection for the GPS device 320 include the laptop 330, as well as WiFi enabled PCs, cell phones and organizers or personal digital assistants (PDAs) such as Palm Pilots or Pocket-PCs with WiFi.

In the embodiment of FIG. 3, the data on the laptop 330 (obtained either from a web search or from an application) may be pushed to a wireless-enabled GPS navigation device 320 in a car. However, in another embodiment, a user may push data from a home computer to a cell phone, and then to the GPS device. This one-way push of data occurs directly from the PC, using a software application and, e.g., text messaging. Accordingly, a wireless-enabled GPS device 220 or 320 can receive GPS provisioning information even when the GPS device 220 or 320 is not used to request such GPS provisioning information.

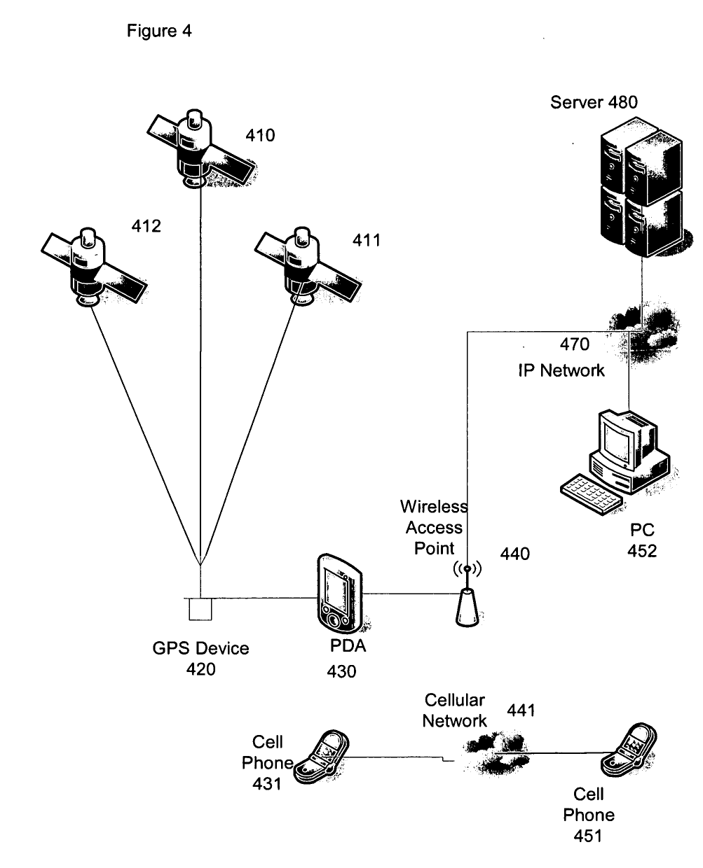

FIG. 4 shows another exemplary network configuration for customized GPS provisioning, in which the user of the GPS device 420 cannot necessarily access the server 480, but is able to contact someone else, e.g., using the cell phone 431, who can access the server 480. As shown in FIG. 4, a cell phone 431 communicates with a cell phone 451 through a cellular network 441. The user of the cell phone 431 is also equipped with an addressable PDA 430 which is connected to the GPS device 420 via, e.g., a USB wire or WiFi functionality. The GPS device 420 is in communication with representative GPS satellites 410-412. The user of the cell phone 451 is also equipped with a PC 452 that can be used to obtain the services of a server 480 through an IP network 470. GPS provisioning information obtained from the application residing on the server 480 can be forwarded to the PDA 430 through the IP network 470, and thereby pushed to the GPS device 420 through the wireless access point 440 and the PDA 430.

As described above, the person providing the provisioning information may be a service subscriber, or even a service operator, a family member, friend or coworker, and can use the PC 452 (or other Internet accessible computer) to look up an address or a business on the Internet using, e.g., a Microsoft Outlook address book, Yahoo Contacts, Yahoo Local or Yahoo Maps. Once the address or business is located, the employee, family member, friend or coworker can push the data to the GPS device 420. The GPS device 420 can use the data to calculate a route to the desired address or business. Alternatively, the forwarded GPS provisioning information may be a map including route information. Therefore, multiple two-way communication links may be used to obtain GPS provisioning information for a GPS device 420.

In the embodiment of FIG. 4, the user of the cell phone 451 and the PC 452 may be an employee of an information or subscription service that provides GPS provisioning information on-demand. Alternatively, the user of the cell phone 451 and the PC 452 may be an emergency services employee that wants to determine a mapped location for a user of the GPS device 420, PDA 430 and cell phone 431. Of course, the user of the cell phone 451 and the PC 452 may be a friend or family member of the user of the cell phone 431. Thus, a user of the GPS device 420 can obtain GPS provisioning information from a remote information source upon demand, even without necessarily having the ability to directly communicate with the server 480 via the IP network 470.

In another embodiment, functionality of a cell phone 431 and a PDA 430 (e.g., voice and data services) may be converged on a single device which is used to obtain GPS provisioning information. Further, the GPS device 420 may be provided with functionality to request and receive provisioning information directly (i.e., without an auxiliary device such as a PDA 430 and/or cell phone 431). Such a GPS device may be provided with an Internet address, a keyboard and/or keypad, a browser and an ability to communicate using, e.g., any of the communications modes described above.

An external data source is not necessary in the embodiment of FIG. 4. Rather, a user collocated in proximity to a computer may directly search for information using the computer and then push the results to a GPS device via WiFi, cell phone text messaging, wireless data transfer, or by loading the data into the cell phone memory. For example, while searching for an address in Outlook or in Yahoo Contacts, a user may be provided with an option “Send To: GPS Device” or “Sent To: Cell Phone”. Similarly, a user searching for a business in a Yahoo Local or Yahoo Maps service could right click on the business name or address and have the same options. Information may be pushed to the GPS device as an address, GPS coordinates or even a .gif image of a local and relevant map. As described above, the information can be pushed via USB, WiFi or other data transfer protocols. Accordingly, a user does not need to manually record information from a computer and manually enter the information into a GPS device.

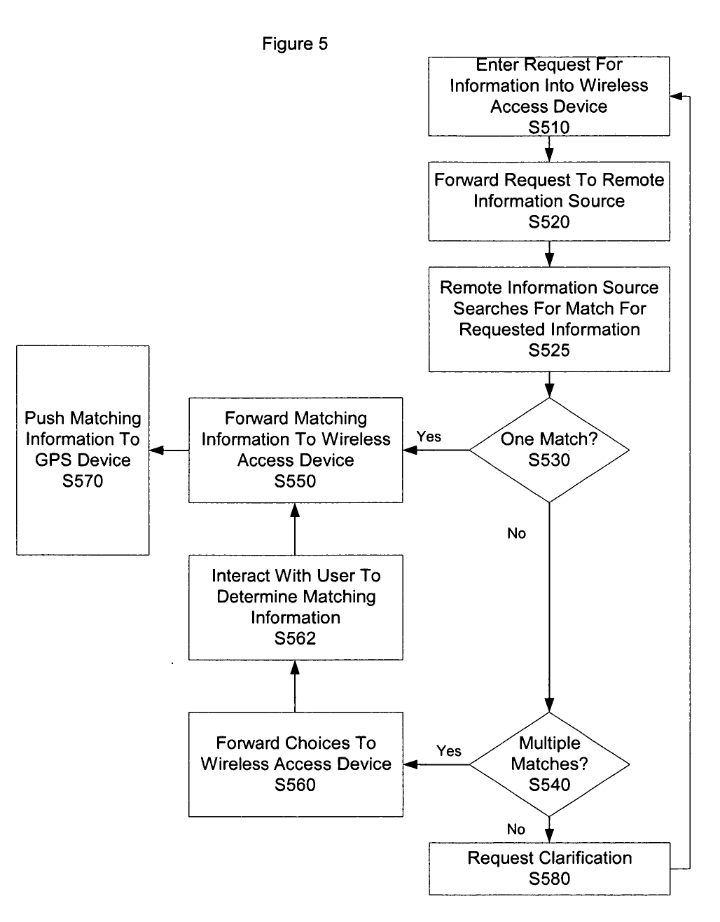

FIG. 5 shows an exemplary method for customized GPS provisioning. As shown, a request for information is entered into a wireless access device at S510. In an embodiment using a cell phone for communications, the request for information may be made by calling a remote information source and verbally requesting an operator, friend, relative or coworker to search for the relevant GPS provisioning information. Alternatively, in the embodiment of FIG. 2, the request for information may be made using the cell phone 230 under the control of the GPS device 220. The request for information is forwarded to the remote information source at S520. At S525, the remote information source searches for the requested information. At S530, a determination is made whether a single match for the request has been found. If a single match for the requested information is found (S530=Yes), the matching information is forwarded to the requester's wireless access device at S550 and the matching information is pushed to the GPS device at S570.

If a single match for the requested information is not found (S530=No), a determination is made at S540 as to whether multiple matches for the request have been found. If multiple matches are found (S540=Yes), information for the multiple matches is forwarded to the user's wireless access device at S560 and the remote information source interacts with the user at S562 to determine which matching information is being sought. When clarification is obtained, the GPS provisioning information is forwarded to the wireless access device at S550 and the matching information is pushed to the GPS device at S570. When no multiple matches are found (S540=No), a request for clarification is sent to the wireless access device at S580.

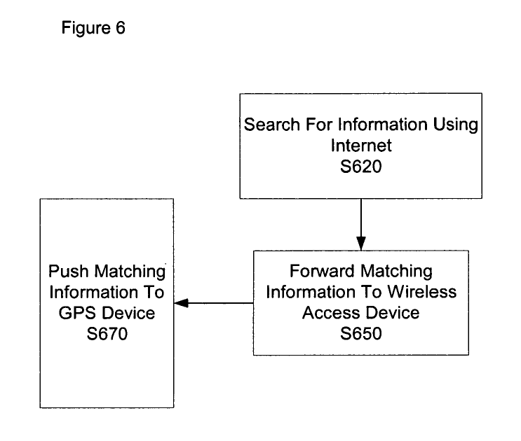

FIG. 6 shows another exemplary method for customized GPS provisioning. In the embodiment of FIG. 6, a co-located user who is personally searching for provisioning information on his or her computer, and who directly provisions the GPS device. At S620, the user searches for information using the Internet. At S650, matching information is forwarded to the wireless access device and at S670 the user pushes the matching GPS provisioning information to the GPS device.

Further, as described above, users can interactively retrieve GPS provisioning information and push the retrieved information to a GPS device through any type of wireless access device, such as a cell phone 230, a laptop 330 or a PDA 430. Of course, although the embodiments shown in FIGS. 2-4 show multiple communications devices being used to request and retrieve customized GPS provisioning information, a GPS device is explicitly contemplated which is itself provided with the functionality to interactively communicate with remote information sources and retrieve customized GPS provisioning information.

Further, as described above with respect to FIG. 4, 2-way communication may be provided between a caller and, for example, an operator. The operator is able to obtain GPS information from a software application residing on a PC 452 or from a server 480. The GPS information is then pushed to the exemplary PDA 430. Of course, a human operator is not needed as a remote information source. Rather, as shown in the embodiments illustrated in FIGS. 2 and 3, the functionality described above can be automated and provided with a server and/or managed database.

Although the present specification describes components and functions that may be implemented in particular embodiments with reference to particular standards and protocols, the invention is not limited to such standards and protocols. Each of the standards, protocols (e.g., USB protocols, Wi-Fi protocols, Bluetooth protocols) and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A method for dynamically provisioning a global positioning satellite device, comprising:
receiving global positioning satellite device provisioning information for at least one specified location from an information source over a communications network; and
transferring the received global positioning satellite device provisioning information to the global positioning satellite device.

2. The method for dynamically provisioning a global positioning satellite device of claim 1, further comprising:
requesting the global positioning satellite device provisioning information from the information source over a wireless network.

3. The method for dynamically provisioning a global positioning satellite device of claim 2,
wherein the request for global positioning satellite device provisioning information is made from a wireless access device and the global positioning satellite device provisioning information is received by the wireless access device.

4. The method for dynamically provisioning a global positioning satellite device of claim 3, further comprising:
transmitting an identifier of the wireless access device with the request for global positioning satellite device provisioning information.

5. The method for dynamically provisioning a global positioning satellite device of claim 4,
wherein the request for global positioning satellite device provisioning information is made to an information service that forwards the requested global positioning satellite device provisioning information when the identifier is associated with a subscriber account.

6. The method for dynamically provisioning a global positioning satellite device of claim 3,
wherein the global positioning satellite device provisioning information received from the information source over the wireless network comprises multiple alternative locations.

7. The method for dynamically provisioning a global positioning satellite device of claim 3,
wherein the global positioning satellite device provisioning information received from the information source over the wireless network is used by the global positioning satellite device to determine a route from a current location of the global positioning satellite device to a location corresponding to the global positioning satellite device provisioning information.

8. The method for dynamically provisioning a global positioning satellite device according to claim 2, wherein the request is made over the wireless network to a remote information source.

9. The method for dynamically provisioning a global positioning satellite device according to claim 2, wherein the wireless network comprises a local area network.

10. A computer readable medium for storing a computer program that dynamically provisions a global positioning satellite device, the computer readable medium comprising:
an information receiving code segment that receives global positioning satellite device provisioning information for at least one specified location from an information source; and
an information transferring code segment that transfers the received global positioning satellite device provisioning information to the global positioning satellite device.

11. The computer readable medium of claim 10,
wherein the global positioning satellite device provisioning information is received as an email.

12. The computer readable medium of claim 10,
wherein the global positioning satellite device provisioning information is received as a text message.

13. The computer readable medium of claim 10,
wherein the global positioning satellite device provisioning information is transferred over a network that conforms to an Institute of Electrical and Electronics Engineers 802.11 protocol.

14. The computer readable medium of claim 10,
wherein the global positioning satellite device provisioning information comprises map data that is used to display a route from a current location to the at least one specified location.

15. A device for dynamically provisioning a global positioning satellite device, comprising:
a receiver that receives global positioning satellite device provisioning information for at least one specified location from an information source; and
a transmitter that transfers the received global positioning satellite device provisioning information to the global positioning satellite device.

16. The device for dynamically provisioning a global positioning satellite device of claim 15, wherein the device comprises a cell phone.

17. The device for dynamically provisioning a global positioning satellite device of claim 15, wherein the device comprises a personal data assistant.

18. The device for dynamically provisioning a global positioning satellite device of claim 15, wherein the device comprises a laptop computer.

19. The device for dynamically provisioning a global positioning satellite device of claim 16, wherein the global positioning satellite device provisioning information is received over a cellular network.

20. The device for dynamically provisioning a global positioning satellite device of claim 18, wherein the global positioning satellite device provisioning information is received over a wireless data network.

21. The device for dynamically provisioning a global positioning satellite device of claim 15, wherein the global positioning satellite device provisioning information is automatically updated based upon a changed location of the global positioning satellite device.

22. The device for dynamically provisioning a global positioning satellite device of claim 15, wherein the global positioning satellite device provisioning information comprises a first map for a first area received at a first time when the global positioning satellite device is at a first location in the first area and a second map for a second area received at a second time when the global positioning satellite device is at a second location in the second area.
